(19) United States
(12) Patent Application Publication
(10) Pub. No.: US 2011/0112877 A1
(43) Pub. Date: May 12, 2011

(54) Method and Apparatus for Constraint-based Staff Scheduling

(76) Inventors: Nirmal Govind, San Francisco, CA (US); Suvas Vajracharya, San Francisco, CA (US); Richard Shafer, San Mateo, CA (US)

(21) Appl. No.: 12/615,099

(22) Filed: Nov. 9, 2009

(51) Int. Cl. G06Q 10/00; G06Q 50/00

(52) U.S. Cl. 705/7.13

(57) ABSTRACT

A constraint-based framework models and solves the problem of assigning staff, for example a set of cardiologists, to various work-shifts or work-assignments, for example a day shift and a night shift, for a pre-defined scheduling horizon, for example three months. A work-schedule is produced, which is defined as a list of staff-shift or staff-assignment combinations that meet the various criteria set by the staff and the healthcare facility on how the staff need to work. The staff then uses this work-schedule to perform the needed activities for the amount of time specified by the scheduling horizon. The scheduling problem is modeled with the help of constraints and variables to express the physical constraints specified by the staff on their work schedules and the needs of the healthcare facility. By embedding the scheduling model within a software program, a work-schedule is produced quickly that meets the requirements of the staff and the healthcare facility.

### BACKGROUND OF THE INVENTION

1. Technical Field

The invention relates to the healthcare industry. More particularly, the invention relates to a method and apparatus for constraint-based staff scheduling in the healthcare industry.

2. Description of the Prior Art

Health care institutions require flexibility in dealing with complex scheduling requirements for physicians and nurses scheduling. Unfortunately, there is no robust solution to scheduling requirements for such aspects of health care institution staffing as temporary or contract staff scheduling, hospitalist scheduling, resident scheduling, on call scheduling, shift scheduling, circadian rhythm scheduling, and block scheduling, especially when various constraints and other factors are taken into consideration.

### SUMMARY OF THE INVENTION

An embodiment of the invention provides a constraint-based framework to model and solve the problem of assigning staff, for example a set of cardiologists, to various work-shifts or work-assignments, for example a day shift and a night shift, for a pre-defined scheduling horizon, for example three months. The solution to the scheduling problem is a work-schedule, which is defined as a list of staff-shift or staff-assignment combinations that meet the various criteria set by the staff and the healthcare facility on how the staff need to work. The staff then uses this work-schedule to perform the needed activities for the amount of time specified by the scheduling horizon. The problem is inherently combinatorial and becomes quickly intractable as the number of staff and/or work-shifts increases and/or length of scheduling horizon increases. A presently preferred embodiment of the invention models the scheduling problem with the help of constraints and variables to express the physical constraints specified by the staff on their work schedules and the needs of the healthcare facility. By embedding the scheduling model within a software program, the invention provides a technique that is able to produce a work-schedule quickly that meets the requirements of the staff and the healthcare facility.

### BRIEF DESCRIPTION OF THE DRAWINGS

FIG. 1 is a flow diagram showing an algorithm for defining a work-pattern constraint according to the invention;

FIG. 2 is a flow diagram showing an algorithm for scheduling staff resources according to the invention;

FIG. 3 is a block schematic diagram showing an architecture for an enterprise-based implementation of the invention; and

FIG. 4 is a block schematic diagram of a machine in the exemplary form of a processor implemented computer system within which there is a set of instructions for causing the machine to execute any one or more of the functions and/or steps of the embodiments of the invention disclosed herein.

### DETAILED DESCRIPTION OF THE INVENTION

An embodiment of the invention addresses the problem of scheduling staff resources. The context used is the healthcare industry, however, the invention is applicable to any industry where staff must be scheduled based on certain restrictions or constraints on how work is performed. In the healthcare context, staff may include full-time and part-time physicians, nurse practitioners, and administrative personnel. For purposes of the discussion herein, the term “healthcare” refers to a broad range of services, including hospitals, clinics, private practices, emergency departments, urgent care, etc.

An embodiment of the invention provides a constraint-based framework to model and solve the problem of assigning staff, for example a set of cardiologists, to various work-shifts or work-assignments, for example a day shift and a night shift, for a pre-defined scheduling horizon, for example three months. The solution to the scheduling problem is a work-schedule, which is defined as a list of staff-shift or staff-assignment combinations that meet the various criteria set by the staff and the healthcare facility on how the staff need to work. The staff then uses this work-schedule to perform the needed activities for the amount of time specified by the scheduling horizon. The problem is inherently combinatorial and becomes quickly intractable as the number of staff and/or work-shifts increases and/or length of scheduling horizon increases. A presently preferred embodiment of the invention models the scheduling problem with the help of constraints and variables to express the physical constraints specified by the staff on their work schedules and the needs of the healthcare facility. By embedding the scheduling model within a software program, the invention provides a technique that is able to produce a work-schedule quickly that meets the requirements of the staff and the healthcare facility.

Advantages of the invention include:
Balancing various needs: The invention provides a technique that creates a work-schedule that makes optimal use of staff resources in such a way that it meets both institutional and individual needs.
Priority-based rules and constraints: The invention provides a technique that allows for priorities to specify the preference of the end-user for one rule or constraint over another rule or constraint.
Hard and soft rules and constraints: The invention provides a technique that models both hard rules or constraints, i.e. rules or constraints that must be met, as well as soft rules or constraints that the system must strive to meet but need not meet.
Detection and display of violations: The invention provides a technique that detects inconsistent rules or constraints that are specified by the end-user that result in infeasibilities. This information is of critical importance to the end-user to understand and correct the inconsistencies. The invention provides a technique that displays these violations to the end-user via a graphical user interface implemented using software.
Generation of work-schedules in the presence of violations: The invention provides a technique that can produce a work-schedule that meets all the rules and constraints that do not have any inconsistencies, while excluding the rules or constraints that are inconsistent. This ensures that the end-user has at least one work-schedule to work with as a starting point while the inconsistencies are addressed.
Analysis of resource needs: The invention provides a technique that performs the analysis of staff resources needed to meet institutional work requirements while considering soft objectives defined by work-life balance needs for staff members.
Accuracy/goodness: The invention provides a technique that models all needed constraints accurately, thereby producing a work-schedule that meets the requirements. This accuracy or goodness is the main criterion for success of a healthcare staff scheduling method because the schedule affects the daily lives of the staff. Heuristic systems that partially model the constraints or violate some of the constraints specified do not achieve the same level of accuracy/goodness.
Speed/performance: The invention provides a technique that is implemented using this scheduling method and a framework that generates a work-schedule fairly quickly, allowing for faster response times for the staff. This also enables the staff to perform “what-if” analyses by tweaking the constraints that are placed on the system to find the best set of constraints that suits their needs.
Flexibility: The modeling framework is general enough to allow for all the constraints that have been encountered in the healthcare staff scheduling problem: See, Gendreau, Michel, Jacques Ferland, Bernard Gendron, Noureddine Hail, Brigitte Jaumard, Sophie Lapierre, Gilles Pesant, and Patrick Soriano (2007), Physician Scheduling in Emergency Rooms, Practice and Theory of Automated Timetabling VI, 53-66 (http://dx.doi.org/10.1007/978-3-540-77345-0_{—}4); Huguette Beaulieu, Jacques Ferland, Bernard Gendron, and Philippe Michelon, (2000), A mathematical programming approach for scheduling physicians in the emergency room, Health Care Management Science 3, no. 3, Health Care Management Science: 193-200; and Rousseau, Louis-Martin, Gilles Pesant, and Michel Gendreau, (2002), A General Approach to the Physician Rostering Problem, Annals of Operations Research 115, no. 1: 193-205, doi:10.1023/A:1021153305410. The framework is easily extensible to include new constraints that may be placed on the system in the future.

### Terminology

The healthcare staff-scheduling problem is governed by a few basic entities: time (modeled by period or period-group), staff, work-shifts, and bounds on number of work-shifts or staff or time (periods) that are expressed via mathematical relations. A few basic definitions that allow for the full specification of the method and system are as follows:

Period: a pre-defined duration of time that has a specific start time and end time. A period is also the smallest scheduling unit.

Period-group: a collection of distinct periods that can be used to define a work-schedule or to help specify a rule that needs to be adhered to by the work-schedule.

Work-shift: a pre-defined work slot, a particular shift, or block of time of a particular type of service on a particular day. A work-shift can span exactly one period, though it may occur on several periods. A work-shift as defined herein can also logically represent a non-working shift where no service is performed.

Work-shift-group: a collection of work-shifts that may include a single work-shift and can be the entire set of work-shifts. A work-shift-group can be used to specify a sequence of work-shifts.

Staff: a staff member that needs to be scheduled by the system or has a pre-specified schedule that needs to be considered by the system.

Staff-group: a set of staff members that are grouped based on pre-defined criteria.

### Elements of a Preferred Embodiment

A preferred embodiment of the invention captures the healthcare staff-scheduling problem using a mathematical framework. Key elements of this modeling framework are described below. To express the aspect of time in the scheduling problem, a vector of period-groups, where each period-group consists of several periods is defined. Mathematically, this is equivalent to a matrix of periods. In a similar manner, we define a vector of work-shift-groups, where each work-shift-group consists of several work-shifts. For example, a vector of work-shift-groups that consists of two groups of work-shifts, Nights and Days, would be represented by

$$WG = ( \begin{matrix}Nights \\ Days\end{matrix} ) .$$

And finally, we have a matrix, where each element represents a staff-group that could consist of one or more staff. For example, two staff-groups, NightCardiologists and DayCardiologists, could be used to specify requirements for the two work-shift-groups specified above. Thus, the staff-group matrix could be represented by

$$SG = ( \begin{matrix}NightCardiologists \\ DayCardiologists\end{matrix} ) .$$

To represent a scheduling constraint that involves one or more period-groups, one or more work-shift-groups, and one or more staff-groups, the invention provides a technique that models a matrix of bounds that specifies numeric values that can be used to generate constraints with the help of mathematical equality and inequality relations. For example, if at least one staff from DayCardiologists and one staff from NightCardiologists is required for work-shift-group Days and Nights respectively, a bounds matrix could be represented by

$$B = ( \begin{matrix}1 \\ 1\end{matrix} ) .$$

The inventive technique combines these elements to capture various types of constraints of the healthcare staff-scheduling problem. To do this, the inventive technique defines the notion of a work-pattern based on these elements. Using a combination of a period-group matrix, a work-shift-group matrix, a staff-group matrix, a bound matrix and a relations matrix, it is possible to define a work-pattern, which can then be used to construct rules that specify various constraints on how the staff can or cannot be assigned, and also to specify the demand for an assignment.

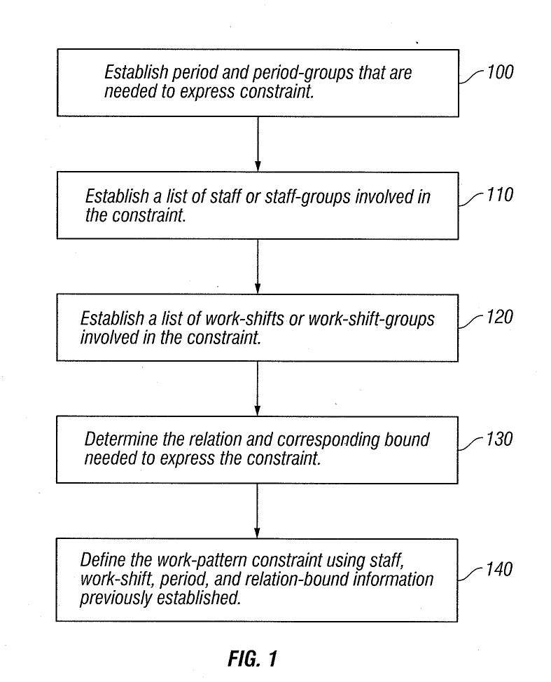

FIG. 1 is a flow diagram showing an algorithm for defining a work-pattern constraint according to the invention.

At a first step (100), periods and period-groups that are needed to express constraints are established. For example, one constraint might be that staff members must be available every other Monday.

A list of staff or staff-groups involved in the constraint is established (110), for example doctors X and Y are added to the list because they meet the constraint.

A list of work-shifts or work-shift-groups involved in the constraint is then established (120), for example the daily on-call shift is added to the list because they meet the constraint.

The relation and corresponding bound needed to express the constraint or rule is then determined (130). For example, the relation may be expressed as ≧, bound:1, etc.

The work-pattern constraint using staff, work-shift, period, and relation-bound information thus established is defined (140). For example, the work-pattern constraint could be:
[Every Other Monday]<->[Doctors X and Y]<->[Daily On-Call]≧1.

### Constraints

There are different types of constraints for the healthcare staff-scheduling problem. A non-exhaustive classification is given below. Note that the constraints could be soft or hard. If soft, a priority is associated with the constraint. Thus, each constraint possesses two attributes:

(1) Hardness Indicator to indicate whether the constraint is a must-have (hard) constraint; and,
(2) Priority to indicate how much importance should be given to satisfying the constraint if it is not a must-have constraint (not hard).

There exist several types of constraints that are modeled by the inventive technique using the modeling framework described above. A categorization of the most commonly observed constraints in healthcare staff scheduling are provided below:
Skills-based: Not all staff can perform all work-shifts. For example, nurse practitioners cannot perform the work-shifts that can only be done by physicians, a neuro-radiologist may not be able to perform the work-shifts that can only be done by an interventional radiologist, etc. Hence, skills-based constraints are necessary to specify that staff can only perform work-shifts that they are qualified to do. Below is a broad classification of skills-based constraints:
   Demand: This constraint expresses the required number of staff of a particular type or skill-set that are needed for a work-shift for a specified period-group. Using the notion of work-patterns, this can be expressed as: in a given period-group P, the number of staff from staff-group S needed for work-shift-group W is at least N.
   Qualification: This constraint indicates the types of work-shifts that staff can cover during a specified period-group.
   Compatibility: Certain staff may not be able to perform a particular work-shift in a given period-group if they are also performing another type of work-shift in the same period-group.

Thus, an incompatibility (or equivalently, a compatibility) constraint is necessary to ensure that staff are only scheduled for compatible work-shifts during a given period-group.
Regulations-based: Staff may have regulations in place that may limit the number or type of work-shifts and/or the period-groups that they can perform. A set of regulations constraints takes these into account. With the help of work-patterns, this constraint is expressed as: for a given staff from staff-group S, the number of work-shift-groups of W that can be worked is bounded by B in period-group P. The bound is enforced via the use of relations, as noted above.
Work-pattern-based: Constraints that are based on work-patterns may be classified into two categories:
   Frequency-based, where there exists a constraint on the number of occurrences of a certain work-pattern; and
   Conditional, where constraints take on the form: if work-pattern X occurs then work-pattern Y must (or must not) occur.

As discussed above in connection with FIG. 1, the invention provides a technique that accurately models the above-mentioned constraints and produces a work-schedule that meets these constraints. To implement the model and the solution procedure as an application for the end-users, the invention makes use of software technology to embed programming logic.

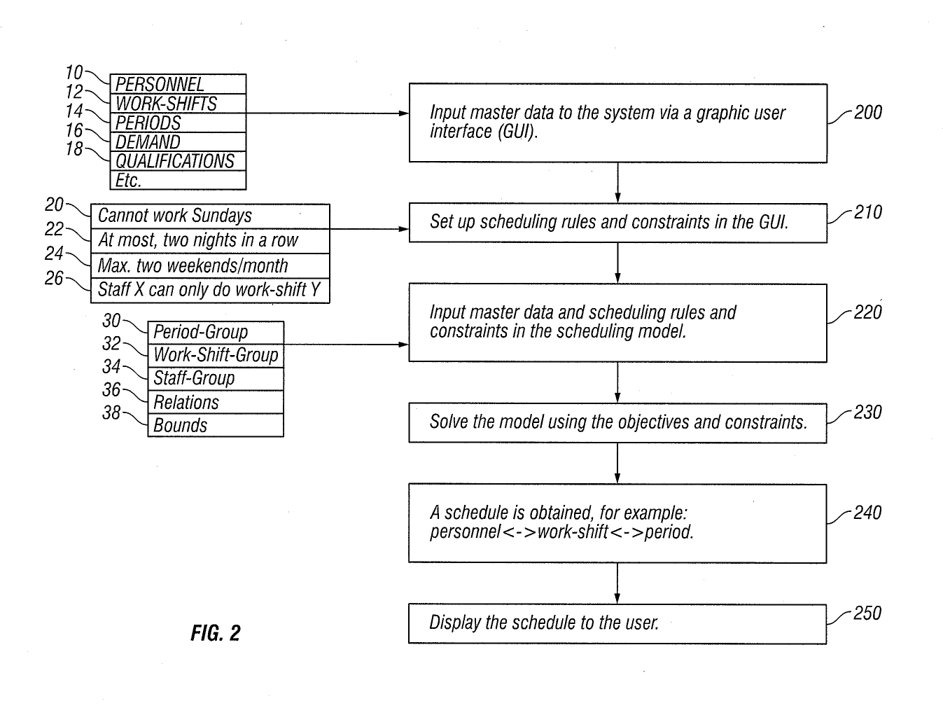

FIG. 2 is a flow diagram showing an algorithm for scheduling staff resources according to the invention.

At a first step (200), master data is input to the system via a graphic user interface (GUI). Such data can include, for example, personnel information 10, work-shift information 12, periods 14, demand 16, and qualifications 18, etc.

Scheduling rules and constraints are then set up in the GUI (210). Such rules and constraints can include, for example, “Cannot work Sundays” 20, “At most, two nights in a row” 22, “Maximum of two weekends in a month” 24, “Staff X can only do work-shift Y” 26, etc.

The first operations, steps (200) and (210), are typically performed in the system at the middleware level, although this is not required to practice the invention.

The master data and scheduling rules and constraints are then input in the scheduling model (220). The scheduling model can include, for example, period-group 30, work-shift-group 32, staff-group 34, relations 36, bounds 38, etc. The model typically resides in the backend of the system architecture, although this is not required to practice the invention.

The system then solves the model using the objectives and constraints (230). Because the model typically resides in the backend of the system architecture, this step is typically performed in the backend of the system architecture although this is not required to practice the invention.

A schedule is then obtained, for example showing:

personnel<->work-shift<->period (240).

The schedule is provided at the middleware level, although this is not required to practice the invention.

The schedule is then displayed to the user (250), for example via the GUI.

### Software

The invention embeds the logic for modeling the constraints into a software application that can be invoked on an as-needed basis. The software application is hosted by a Web server that serves requests from a client, such as a personal computer used by an end-user, for example the scheduling administrator for a group. Data is exchanged between the software application and the client via standard Extensible Markup Language (XML) protocol or an alternate protocol.

### System Architecture

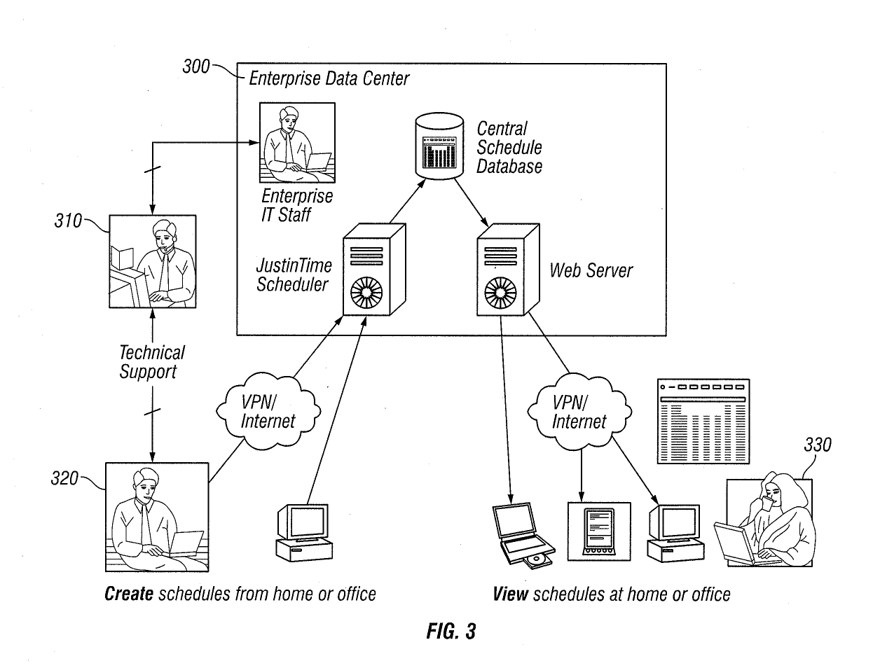

FIG. 3 is a block schematic diagram showing an architecture for enterprise-based implementation of the invention. Those skilled in the art will appreciate that the invention may be practiced according to any other architectural model, such as in a hosted server or dedicated hosted server. In the embodiment of FIG. 3, users 320, 330 log-in to servers residing at an enterprise data center 300. In this subscription model, users can create (320) and view (330) schedules from anywhere, provided they have a connection to the Internet. Users do not need to own any extra hardware, other than a computer with a Web browser. Technical support personnel 310 work with the scheduler at a clinic or hospital to generate a fair, accurate schedule meeting individual and institutional needs. One embodiment of the invention uses Microsoft Remote Desktop technology to allow technical support at the enterprise data center to concurrently log-in with the scheduler to view the same screen along with sharing keyboard/mouse activities to better address their questions.

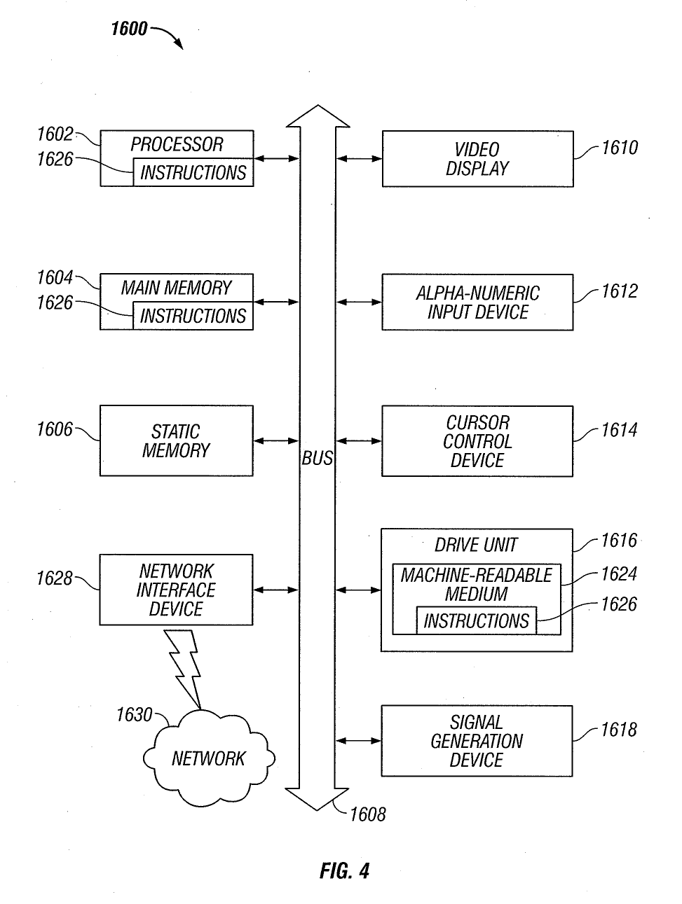

FIG. 4 is a block schematic diagram of a machine in the exemplary form of a computer system 1600 within which a set of instructions for causing the machine to perform any one of the foregoing methodologies may be executed. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1620.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1628, 1630 by means of a network interface device 1620.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A computer implemented method for scheduling staff resources in the healthcare industry, comprising the steps of:
providing a processor implemented, constraint-based framework to assign staff to various work-shifts or work-assignments in one or more healthcare facilities for a pre-defined scheduling horizon;
said framework receiving inputs defining a work-schedule comprising a list of staff-shift or staff-assignment combinations that meet various criteria set by said staff and said one or more healthcare facilities on how the staff need to work;
said framework processing said inputs to determine a work-schedule for performing needed healthcare facility activities for an amount of time specified by said scheduling horizon;
said framework applying constraints and variables to said work-schedule to express physical constraints specified by said staff on their work schedules, and said framework then reconciling said physical constraints with the needs of said healthcare facility; and
said framework determining a work-schedule that meets the constraints of said staff and the needs of said healthcare facility, and said framework then outputting a user perceptible representation of said work-schedule.

2. The method of claim 1, further comprising the step of:
said framework applying priorities to said work-schedule determination that specify a preference of an end-user for one rule or constraint over another rule or constraint.

3. The method of claim 1, further comprising the step of:
said framework modeling both hard rules comprising constraints that must be met and soft rules comprising constraints should be met but need not meet.

4. The method of claim 1, further comprising the step of:
said framework displaying violations that result in infeasibilities to an end-user.

5. The method of claim 1, further comprising the step of:
said framework producing a work-schedule that meets all rules and constraints that do not have any inconsistencies, while excluding rules or constraints that are inconsistent to ensure that an end-user has at least one work-schedule to work with as a starting point while the inconsistencies are addressed.

6. The method of claim 1, further comprising the step of:
said framework performing an analysis of staff resources needed to meet institutional work requirements while considering soft objectives defined by work-life balance needs for staff members.

7. The method of claim 1, further comprising the step of:
said framework modeling all needed constraints accurately to produce a work-schedule that meets all requirements.

8. The method of claim 1, further comprising the step of:
said framework enabling said staff to perform “what-if” analyses by altering said constraints to find the best set of constraints for said staff's needs.

9. The method of claim 1, further comprising the step of:
said framework determining said work-schedule pursuant to a processor implemented resolution of a healthcare staff-scheduling problem that is governed by factors which comprise any of time (modeled by period or period-group), staff, work-shifts, and bounds on number of work-shifts or staff or time (periods) that are expressed via mathematical relations.

10. The method of claim 9, said factors comprising any of:
period, which comprises a pre-defined duration of time that has a specific start time and end time, a period comprises a smallest scheduling unit;
period-group, which comprises a collection of distinct periods that can be used to define a work-schedule or to help specify a rule that needs to be adhered to by said work-schedule;
work-shift, which comprises a pre-defined work slot, a particular shift, or block of time of a particular type of service on a particular day, wherein a work-shift can either span exactly one period, or it can occur on several periods, and wherein a work-shift can also logically represent a non-working shift where no service is performed;
work-shift-group, which comprises a collection of work-shifts that may either include a single work-shift or an entire set of work-shifts, and wherein a work-shift-group can be used to specify a sequence of work-shifts;
staff, which comprises a staff member that needs to be scheduled or who has a pre-specified schedule that needs to be considered; and
staff-group, which comprises a set of staff members that are grouped based on pre-defined criteria.

11. The method of claim 9, said mathematical relations expressing an aspect of time in said staff-scheduling problem as a result of executing the following processor implemented steps:
defining a vector of period-groups, where each period-group consists of several periods, said vector comprising a matrix of periods;
defining a vector of work-shift-groups, where each work-shift-group consists of several work-shifts; and
defining a matrix, where each element represents a staff-group that could consist of one or more staff.

12. The method of claim 9, said mathematical relations representing a processor implemented scheduling constraint comprising one or more period-groups, one or more work-shift-groups, and one or more staff-groups;
said framework modeling a matrix of bounds that specifies numeric values that can be used to generate constraints with the help of mathematical equality and inequality relations.

13. The method of claim 1, further comprising the steps of:
said framework using a combination of a period-group matrix, a work-shift-group matrix, a staff-group matrix, a bound matrix and a relations matrix to define a work-pattern; and
said framework using said work-pattern to construct rules that specify various constraints on how said staff can or cannot be assigned, and also to specify a demand for an assignment.

14. A computer implemented method for defining a work-pattern constraint, comprising the steps of:
establishing, with a processor, periods and period-groups that are needed to express constraints;
establishing, with said processor, a list of staff or staff-groups involved in said constraint;
establishing, with said processor, a list of work-shifts or work-shift-groups involved in said constraint;
determining, with said processor, a relation and corresponding bound needed to express a constraint or rule; and
defining, with said processor, said work-pattern constraint using said staff, work-shift, period, and relation-bound information thus established.

15. The method of claim 14, wherein said constraints comprise any of soft and hard constraints.

16. The method of claim 14, further comprising the step of:
associating a priority with a soft constraint.

17. The method of claim 14, wherein each constraint possesses the following two attributes:
a hardness indicator to indicate whether the constraint is a must-have (hard) constraint; and
a priority to indicate how much importance should be given to satisfying the constraint if it is not a must-have constraint (not hard).

18. The method of claim 14, said constraints comprising any of:
skills-based constraints, which comprise constraints that are necessary to specify that staff can only perform work-shifts that they are qualified to perform, said skills-based constraints comprising any of:
a demand constraint which expresses a required number of staff of a particular type or skill-set that are needed for a work-shift for a specified period-group, in a work-pattern the demand constraint is expressed as: in a given period-group P, the number of staff from staff-group S needed for work-shift-group W is at least N;
a qualification constraint which indicates types of work-shifts that staff can cover during a specified period-group; and
a compatibility constraint which ensures that staff are only scheduled for compatible work-shifts during a given period-group;
regulations-based constraints, which comprise regulations in place that limit a number or type of work-shifts and/or the period-groups that staff can perform, in a work-pattern the regulations constraint is expressed as: for a given staff from staff-group S, the number of work-shift-groups of W that can be worked is bounded by B in period-group P, wherein the bound is enforced via the use of relations;
work-pattern-based constraints, which are based on work-patterns that are classified as either of:
frequency-based constraints on the number of occurrences of a certain work-pattern; and
conditional constraints which take on the form: if work-pattern X occurs then work-pattern Y must (or must not) occur.

19. A computer implemented method for scheduling staff resources, comprising the steps of:
inputting master data to a processor via a graphic user interface (GUI), said data comprising any of personnel information, work-shift information, periods, demand, and qualifications;
establishing scheduling rules and constraints with said processor via said GUI;
said processor inputting said master data and said scheduling rules and constraints into a scheduling model, said scheduling model comprising any of period-group, work-shift-group, staff-group, relations, and bounds;
said processor solving said model using said rules and constraints;
said processor obtaining a schedule;
said processor providing said schedule for display to a user via the GUI.

20. An apparatus for scheduling staff resources in the healthcare industry, comprising:
a processor implemented, constraint-based framework to assign staff to various work-shifts or work-assignments in one or more healthcare facilities for a pre-defined scheduling horizon;
said framework configured for receiving inputs defining a work-schedule comprising a list of staff-shift or staff-assignment combinations that meet various criteria set by said staff and said one or more healthcare facilities on how the staff need to work;
said framework configured for processing said inputs to determine a work-schedule for performing needed healthcare facility activities for an amount of time specified by said scheduling horizon;
said framework configured for applying constraints and variables to said work-schedule to express physical constraints specified by said staff on their work schedules, and said framework then reconciling said physical constraints with the needs of said healthcare facility; and
said framework said framework determining a work-schedule that meets the constraints of said staff and the needs of said healthcare facility, and said framework then outputting a user perceptible representation of said work-schedule.
